(19) United States
(12) Patent Application Publication
(10) Pub. No.: US 2007/0129067 A1
(43) Pub. Date: Jun. 7, 2007

(54) Ring-tone system and methodology

(76) Inventors: Robert D. Summer, New York, NY (US); Talmon Marco, New York, NY (US); Jon M. Dickinson, Portland, OR (US)

Correspondence Address: ROBERT D. VARITZ, P.C., 4915 SE 33RD PLACE, PORTLAND, OR, 97202, US

(21) Appl. No.: 11/588,521

(22) Filed: Oct. 27, 2006

Related U.S. Application Data
(60) Provisional application No. 60/733,594, filed on Nov. 4, 2005.

(51) Int. Cl. H04Q 7/38; H04Q 7/22; H04M 3/42

(52) U.S. Cl. 455/414.1

(57) ABSTRACT

A system, and an associated network ring-tone communication method, enabling creation and use of a personalized, user-defined communication ring-tone. The invention method includes (a) selectively placing, in an electronic ring-tone depot, digital snippet content suitable for extraction and use as at least a part of a digital communication ring-tone, (b) enabling controlled and sanctioned user access to that depot for the purpose of permitting selective user-extraction therefrom of at least one depot-held content snippet, and (c) further enabling user-employment of such an extracted snippet as at least a part of (1) a user-specific communication identifier, and/or (2) an ultimate, user-identifying action-stimulator, in relation to a user-to-another network communication.

### CROSS REFERENCE TO RELATED APPLICATION

This application claims priority to U.S. Provisional Patent Application Ser. No. 60/733,594, filed Nov. 4, 2005, for “Ring-Tone System and Methodology”. The entire disclosure content of that prior-filed provisional case is hereby incorporated herein by reference.

### BACKGROUND AND SUMMARY OF THE INVENTION

This invention relates to what we refer to herein as a digital ring-tone network system and methodology, where the term “network” refers to a wired or wireless communication medium. More particularly, it pertains to such a system and methodology which offer to a user (to be defined below), in the context of placing a call, or otherwise being involved as a participant at one end of a current (or prospective) communication event, the opportunity to acquire, to modify if desired, and to use, a unique, personalized, digital-media “ring-tone”, or digital-control-signal (action-producing) “ring-tone”, designed to catch the attention of a recipient party, or of plural recipient parties, with a clear identification of the communication initiator.

A non-exhaustive list of potential users includes (a) a cell-phone user, (b) a computer network communicator, (c) a PDA (personal digital assistant) network communicator, (d) a computer application capable of communication, or having features suited for communication, invoked by a “calling” user to communicate to a receiving party, including to a receiving computer and/or another computer application, (e) a call recipient, and (f), many other kinds and characters of communication initiators, including land-line communicators.

This invention thus proposes, among other things which will be discussed below, a system and a methodology which place, principally, though not always, “in the hands” of a communication initiator, both (a) control over the nature of a “reception alert” received by a “called” party, and (b) vast creative control over the specific “personality” of such an alert. In some instances, such controls may be exercised by a “called” party.

The term “ring-tone”, as used in this disclosure, possesses a broad definition, and includes, without limitation, ring-tone-suitable digital subject matter, such as digital audio, video (including film) and text media snippets drawn from a snippet depot to which the user has been provided access, including rights-sanctioned access with respect to any “rights-holder” media content which is resident in that depot. With regard to such rights-holder media content, rights sanctioning can exist in various selectable ways, one of which is discussed below herein. “Ring-tone” also includes various selectable, depot-held forms of digital-data, action-producing, user-identifying control signals for triggering different forms of remote actions or functions at a relevant communication reception site. Such an action might include placing a selected image on a recipient party's computer display screen.

Specifically contemplated by the present invention is the creation and existence of a user-searchable depot—the above-mentioned snippet depot—which may be centralized or distributed. With regard to rights-holder media content, the depot is constructed to function as a sanctioned, authorized-user-searchable repository containing such content. “Rights-holder media content” herein includes electronic files of copyright-controlled, digital, audio, video, film, text, and performance, etc., materials, some of which may be owned/controlled/managed by the well-known, large media music, broadcast and moving-image industries.

The term “snippet” refers, among other things, to a digital portion, or passage, of any size (including all), of depot media content recognizably drawn from a recorded song track, a movie made for theatre or television, a speech, a radio or television broadcast, a performance or sporting or other-type event, and so on. It also refers to digital media subject matter which has been created specifically by a user for his, or her, own use. An example of this is subject matter associated with the so-called “YouTube” Internet phenomenon. Further, a “snippet” can take the form of digital control-signal data.

The term “rights-holder”, as employed in this text, refers to any party who holds licensable copyright rights attached to a digital-media snippet.

With respect to rights-holder depot content, the invention further contemplates the establishment and existence of appropriate rights-holder permissions (i.e., de facto licenses/sanctions) attached to that content so as to free, from any copyright-infringement stigma, properly authorized users of this invention.

Authorized users include parties who have become such by paying a defined subscription fee, or some other form of payment, to a provider of the services which are proposed and offered by practice of the present invention. Such users are accorded, as will be explained below, defined categories of permitted use-access to the rights-holder media snippets contained in the depot of this invention. It should also be understood that authorized users of this invention might include users for whom depot access is essentially a free user benefit which has been “bundled” with another form of user-receiving service. Other types of authorized users may, of course, be created if desired.

In terms of illustrating (non-exhaustively) the proposed structure and methodology of the present invention, as well as certain aspects of the utility of a ring-tone as contemplated by the invention, and understanding the intended breadths of the various language terms set forth above, description of the present invention will now go forward in the context of cell telephony.

At the receiving end of a cell-phone call (or communication) which has employed a ring-tone constructed in accordance with practice of the present invention, the received ring-tone, if audio, may be played on the audio system of a receiving party's cell phone, or if visual, may be structured to play on the screen of that phone. Additionally, a ring-tone prepared by practice of the present invention may perform a wide variety of user-selectable, predetermined, user-identifying functions such as, without limitation, (a) the opening of a selected file associated with a call recipient's cell-phone-linked computer system, (b) the opening of a recipient-relevant e-mail communication, (c) the placing, for appropriate remote-calling assess and use, in the memory of a call-recipient's cell phone of a triggerable copy of the calling party's currently preferred identifying ring-tone, personalized or not with regard to the specific recipient, (d) the establishing of a gateway for peer-to-peer file-sharing, (e) the initiating/activating of something unique to the calling party which is digitally relevant to, and/or exploitable by, the receiving party, (f) the remote prompting of some other cell-phone function or associated computer function, and (g), many other things.

Thus, and as will be appreciated by those generally skilled in the art from a reading of the present invention disclosure, a ring-tone made and employed in accordance with practice of this invention may have a number of different, interesting, and indeed quite entertaining, downstream functionalities. Use of this invention can, in fact, be downright “fun” in relation to the relatively unbounded ways that it stirs and implements, and will stir and implement, the creative imaginations of authorized users.

Considering now several important aspects of the background setting for the present invention, and of its above-suggested whimsical and utilitarian characteristics, in today's digital electronic media and communication world there is intense interest in a host of different, personal electronic devices, and in the abilities of the individuals owning and using these devices to personalize them in many different creative and expressive ways. As the cell phone, the computer, and the world of wireless communication (featuring, of course, the Internet) continue to merge, to mature and to densify in substantial bandwidth capabilities, and otherwise to become more versatile and robust, the personal drives and interests of many such-device owners to establish unique personalization of their devices, and to “do imaginative digital things”, become more richly satisfiable. Not only this, but also the impressively dense world of wireless communication, and its associated features, progressively and expansively offer myriad opportunities for device owners freely to engage in fickleness in their ring-tone personalization “personas” —i.e., “Today I want to project this persona—tomorrow, maybe another one.”

In such a background setting, the role of digital electronic media—audio and video, for example—has entered center stage for many such device owners who are keenly interested in acquiring, exchanging, enjoying, and variously using and experiencing digitally capturable, modifiable, mixable, and retransmittable media, and in particular licensable rights-holder media, such as music song tracks, and television and theatre film clips.

In this kaleidoscopic, but non-symmetric, environment, media rights-holders, such as those in and of “the music, broadcast and film industries”, are keenly aware of the digital-world impact on their businesses, and are eyes-and-ears “on” with respect to hunting for and spotting new and innovative ways to capture relevant market share in this emerging electronic world. Indeed, there is a perceived digital-communication-world threat to conventional media-industry revenue streams, and as a consequence, media industries are strongly focused on disarming this perception by exploring and tapping successfully, and in creative ways, into the “new, electronic, commercial world”. The present invention offers, as one of its special features, a pleasant surprise to these media-industry explorers.

As will be seen, the present invention imaginatively addresses this new digital-behavior realm, and proposes a rich tapestry of unique, commerce-relevant marriage-unions between (a) these interesting, merging electronic-media and communication worlds, and (b) various newly conceived, non-conventional, imaginatively-possible commercial relationships. Participants in these unions include, as illustrations, (a) all users of cell-phone telephony, (b) computer-to-computer communicators, (c) peer-to-peer affinity groups, (d) sellers and licensors of copyright-rights-associated media, (e) individual media-creating artists, and (f) many others.

In now more fully introducing the present invention, we steer one's focus into the world of so-called ring-tones—a world born in the land of telephony. Indeed, an excellent way to illustrate a preferred and fundamental embodiment of the invention is to describe it initially in the conventional context of personal cell phones which directly and routinely use well-understood, relatively simple audio ring-tones that “sound” to announce the arrival of a call at a particular receiving telephone (today, often another cell phone).

A typical cell phone today comes initially equipped with an on-board memory collection of pre-loaded, pre-defined, user-selectable, sound-based ring-tones. Regarding such phones and ring-tones, a flourishing business has quickly grown around the practice of offering for purchase, often over the Internet, a large range of alternatively useable audio/musical ring-tones which can be downloaded, imported, and lodged in a cell phone's available and accessible electronic memory.

Herein lies a key to understanding the thinking behind, and the structure and practice of, the present invention. This key involves the recognition that the electronic, memory-equipped and function-armed environment of cell phones, and of associated computer and network-communication systems, offers the opportunity for cell-phone users to become creative, electronic-media artists in their own rights—individual producers and users of a substantially boundless field of expressive, highly-individuated, media-rich, and not necessarily sound-constrained, new-style personal “ring-tones” which can (a) imaginatively telegraph these users' identities and personalities to call recipients, and (b) initiate many functional, operational modalities substantially instantly with respect to call-receiving friends and others around the globe, among other things which will certainly come to the minds of readers of this invention disclosure.

This “key”, and the various unique and interesting entertainment and utilitarian features and advantages offered by the present invention, will now become more fully apparent as the detailed description of the invention which follows below is read in conjunction with the accompanying drawings.

### DESCRIPTION OF THE DRAWINGS

FIG. 1 is a high-level, block/schematic diagram which illustrates both the system and the methodology of the present invention in one of its preferred forms and manners of practice.

FIG. 2 is a somewhat more simplified, high-level, schematic diagram illustrating core steps employed in the practice of the present invention.

FIG. 3 is a simplified, high-level, block/schematic diagram generally illustrating the core physical structure of the system of the present invention.

### DETAILED DESCRIPTION OF THE INVENTION

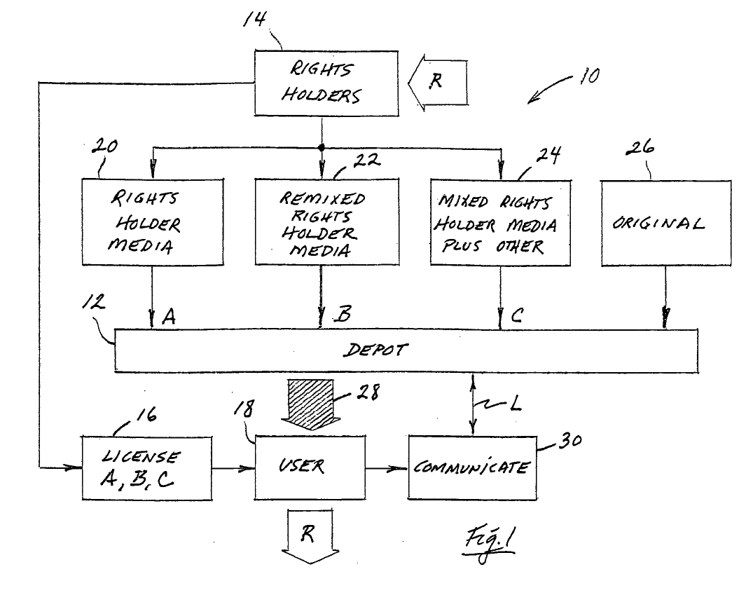

Turning attention now to the drawings, and referring first of all to FIG. 1, indicated generally at 10 are both the system and methodology of the present invention. In the practice of this invention, an electronic ring-tone digital-media-snippet depot 12 is created to hold authorized-user-accessible snippets of various forms of audio, video and text digital media, and digital control-signal data, upon which a system user may draw for the use/creation of a personally selected, personally identifying ring-tone which is to be used with respect to cell-phone calls (communications) placed by that user to another party. This snippet depot may sit (a) entirely within the memory structure of a calling party's cell phone, (b) in the memory of a network server, distributed or centralized, which is accessible to a calling party's cell phone, (c) as pluralities within, for example, the specific distributed memory structures of the cell phones of various parties to whom a particular calling party intends to make calls, or (d) in other appropriate locations at the selection of a system designer designing special use features of the present invention. Depot 12, in the practice of this invention, is populated, as has been stated above, with various forms of digital media snippets, as defined earlier herein, including (a) snippets of media drawn directly from the “reservoirs” of, and supplied to the depot by, the so-called copyright rights-holders, as well, if desired, (b) with original media, such as a photo of one's face, created by a user himself or herself, and (c) control-signal data.

Continuing with FIG. 1, in the practice of the invention, and with regard to the availability and use of rights-holder media, rights-holders, who are represented in FIG. 1 by block 14, supply audio and/or video and/or text, etc. snippets to depot 12, while at the same time effectively extending snippet-use licenses, represented by block 16 in FIG. 1, to authorized users, such as the user who is represented by block 18 in FIG. 1. Block 18, in addition to representing specifically an authorized calling user of the system of the invention as now being described, may also be considered to represent that user's cell phone.

As was mentioned earlier herein, an authorized user may become such through appropriate fee payments made in any suitable manner, such as to a depot manager implementing the business model of a ring-tone subscription service. Via such a service, user-subscriber fees can create profitable, non-conventional, new-form revenue streams to the appropriate recipient parties, including the relevant subscription service provider, and the depot contributors of rights-holder media content.

With respect to the supply of digital-media snippets by rights-holders to depot 12, the embodiment of present invention now being described contemplates, effectively, three different kinds of user licenses which may be extended by rights-holders to a user. These three different licenses are represented by blocks 20, 22, 24 in FIG. 1 which lie in respective arrow-headed flow paths extending between rights-holder block 14 and media-depot block 12. The kind of license represented by block 20, also referred to herein as a type-A license, is a license which permits a user to draw all or a portion only of a rights-holder snippet directly from depot 12 for direct, unmodified use of that snippet (or snippet portion) by the user as a selected ring-tone. The license represented by block 22 in FIG. 1, also referred to as a type-B license, extends to a user the right to select different media snippets within depot 12, and to remix or blend them for the purpose of forming a unique user-blended ring-tone. The third type of license reflected in FIG. 1, represented by block 24 in that figure, and referred to herein as a type-C license, extends to a user the right to mix, with rights-holder media snippets, any other kind of media which has been placed in depot 12, such as a original, user-created media as represented by a block 26 in FIG. 1. Block 26 may also be viewed as representing a user-selected population of digital control-signal data suitable for triggering remote digital actions or functions.

In accordance with practice of the invention, and as is indicated by downwardly pointing, broad, shaded arrow 28 in FIG. 1, an authorized user of system 10 is provided access to the contents of depot 12 for the purpose of searching for, assembling, and using media-snippet content drawn from this depot as a communication ring-tone relative to calls placed by that user. Effectively, and specifically, when a user places a communication call, as represented by block 30 in FIG. 1, a link is made, represented by double-headed arrow L in FIG. 1, to depot 12, however that depot is constructed, for the purpose of finding, extracting, assembling, and then using depot media content as a ring-tone to accompany a placed call. Depending upon a user's licensed authorization, the resulting ring-tone may take on an enormous range of styles and characteristics. Different ring-tones may be created for different call recipients, and/or for triggering different kinds of downstream, user-identifying functions, such as those several functions mentioned earlier herein. Special, multiple-recipient, “multi-faceted” ring-tones may be generated where, for example, an extended ring-tone “composition” might operate with its different “facet pieces” being received differently, and very individually, at the sites of different recipients. Thus, in a very playful way of thinking about imaginative use of the present invention, a ring-tone “composer” might put together a ring-tone audio and video “symphony” which has” movements” that are specifically targeted to a defined set of different call recipients—which recipients might actually only “experience” their own, respective “movements”.

One can thus see the enormous versatility, functional utility, and whimsical playfulness of the system and methodology of the present invention with regard to offering users the opportunity to generate extremely individual and creative identifying ring-tones which accompany call communications placed by a calling party. As contemplated by the present invention, and as has been pointed out, a received ring-tone may do a number of different things, including simply providing a detectible indicator of the presence of an incoming call at a reception site, or performing as an action stimulator in the implementation of some other kind of user-identifying action, such as the opening up of a specific computer-based file at the location of call reception. The illustrations regarding just what a received ring-tone might do with respect to a communication received by a calling party are truly vast in number, and can well be imagined by those skilled in the art possessing an understanding of the concepts lying behind the present invention.

As will also be clearly understandable from thoughts directed to and about the system and methodology of the present invention, practice of this invention offers unique opportunities for the creation of new, collateral revenue streams to people associated with implementing the invention. For example, such collateral, new-form monetary streams can readily be created (a) for one who implements, say, a service-business model based upon the concepts of the invention, (b) for those media-content rights-holders who make digital media content available to the mentioned special depot for ring-tone usage, (c) for commercial carriers in relation to expanded bandwidth usage, and (d) perhaps also for user-device manufacturers.

Regarding income-enhancing possibilities for such rights-holders, this collateral revenue-stream-creating feature of the invention is generally and schematically reflected by the two, broad, unshaded arrows labeled R in FIG. 1. More specifically, if system 10 is based, for example, upon a user-subscription business model as suggested above herein, it is possible that a percentage of subscription fees paid by users of the system will become auxiliary income-stream payments to rights-holders—the levels of which payments might well be independent both of the specific media content selected for use from depot 12, and the number of times that a particular rights-holder's media content is actually selected and used by a user. From another point of view, system 10 might be organized in such a fashion that users' access to rights-holders' snippet media content in depot 12 is exactly tracked for each use, with this trackable use functioning to create specific rights-holders' media payment streams. Still another one of many income-augmenting possibilities involves the option of establishing ready and free access for media rights-holders to a subscriber-user's cell phone, and possibly also to that user's potentially linked computer system, enabling wide-open opportunities for rights-holder promotions for sales of “other” products and services, etc. The “list”, of course, goes on, and is well imaginable by those generally skilled in the art of using electronic communication pathways for advantageous commercial purposes.

There are, of course, in addition to such a user-subscription model, many other business and revenue models which may be implemented in the practice of the methodology of this invention.

Given the current state of the art in media communication over various kinds of networks, it is now well understood that techniques are available for transmitting both audio and video, as well as text digital electronic media, in a high-bandwidth mode of transmission, whereby very faithful and accurate transmissions of sound tracks and video and film clips may readily move from location to location. A consequence of this, of course, is that a user's selected and/or created ring-tone drawn from a depot, such as depot 12, can register at the receiving end of a “call” in a very high-resolution, high-definition manner.

From the description which has thus been given so far regarding the system and methodology of the present invention, blocks 32, 34, 36 in FIG. 3 can been seen to describe graphically the basic core structure of the system of the present invention. With reference thus made to FIG. 3 in the drawings, the system of the present invention can be described and seen as a digital-network, inter-user, ring-tone communication system employing, selectively, as a ring-tone, one, or a blend, of digital rights-holder media, digital non-rights-holder media, and digital control-signal data, and including (a) an electronic ring-tone depot containing such ring-tone media and data content as snippets, (b) network-user access structure operatively associated with, and selectively connectable to, that depot, enabling controlled and sanctioned network-user extraction of at least one snippet derived from depot-contained content, and (c) use-enabling structure operatively associated with the mentioned access structure, operable to enable user-employment of such extracted content as at least a part of (1) a user-specific identifier, and/or (2) a communicable, user-identifying digital-action-stimulator, in relation to a user-to-user digital network communication.

In this systemic definition of the invention, the mentioned ring-tone depot is represented by block 32, the network-user access structure by block 34, and the mentioned use-enabling structure by block 36.

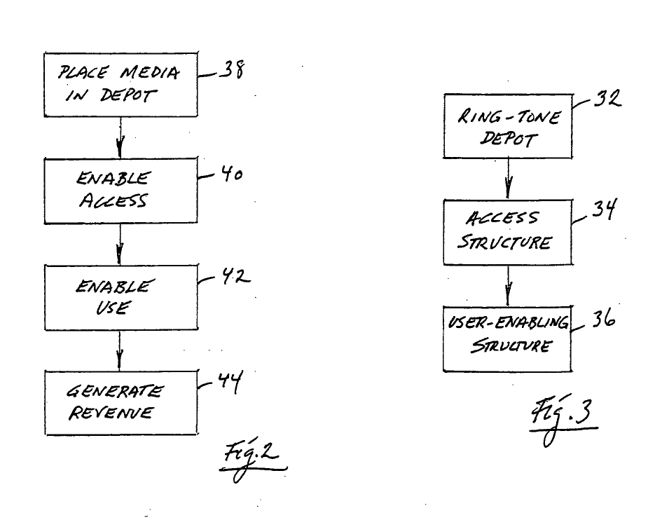

From one methodologic point of view of the invention, and looking now at FIG. 2 in the drawings, the invention can be described as being a network inter-user ring-tone communication method employing, as a ring-tone, one, or a blend, of digital rights-holder media, digital non-rights-holder media, and digital control-signal data, and including the steps of (a) placing such digital media or data as ring-tone snippet content in an electronic ring-tone depot (block 38), (b) enabling authorized-user access to that depot for the purpose of permitting selective extraction by that user of at least one snippet derived from such depot-contained content (block 40), and (c) further enabling user-employment of such extracted content as at least a part of (1) a user-specific identifier, and/or (2) an ultimate, functional, user-identifying action-stimulator, in relation to a user-to-user network communication (block 42). The method additionally includes, in relation to the several placing and enabling steps, the further step of generating, and supplying to rights-holders who are contributors to the ring-tone depot, a revenue stream which is based upon such contributions, but which may be independent, per se, of the count or nature of extractions and use from, and in association with, the depot (block 44).

Yet another methodologic way of viewing the invention is to describe it as a ring-tone network communication method including the steps of (a) selectively placing, in an electronic ring-tone depot, digital snippet content suitable for extraction and use as at least a part of a digital communication ring-tone, (b) enabling controlled and sanctioned user access to that depot for the purpose of permitting selective user-extraction therefrom of at least one depot-held content snippet, and (c) further enabling user-employment of such an extracted snippet as at least a part of (1) a user-specific communication identifier, and/or (2) an ultimate, user-identifying action-stimulator, in relation to a user-to-another network communication.

In practicing this invention, a user is freely enabled to compose an original and unique ring-tone using depot-extracted content as a singularity, or in any blend or mix. Such a ring-tone may be changed dramatically, and at any time, completely at the whim and desire of the user, and can be employed very creatively to express a user's then sense of current personality.

It should be noted that, while the invention has been specifically described herein in the context principally of what a “calling” party can do with respect to his or her own ring-tone identity—an identity which acts as a uniquely personalized communication “alert” at the reception end of a communication—the invention also may be used from the point of view of call reception—a reverse point of view—to create unique ring-tones determined, selected and created from this point of view to be assigned to incoming calls coming from a calling party. Those generally skilled in the art will readily perceive how to implement the system and methodology of the present invention from this reverse perspective.

Accordingly, while a preferred system and methodologic implementation of the invention have been illustrated and described herein, and certain modifications thereto suggested, we appreciate that many other variations and modifications may be made without departing from the spirit of the invention, and we intend that the claims presented herein will have the appropriate scopes to cover all such other variations and modifications.

We claim:

1. A ring-tone network communication method comprising
selectively placing, in an electronic ring-tone depot, digital snippet content suitable for extraction and use as at least a part of a digital communication ring-tone,
enabling controlled and sanctioned user access to that depot for the purpose of permitting selective user-extraction therefrom of at least one depot-held content snippet, and
further enabling user-employment of such an extracted snippet as at least a part of (a) a user-specific communication identifier, and/or (b) an ultimate, user-identifying action-stimulator, in relation to a user-to-another network communication.

2. A network inter-user ring-tone communication method employing, as a ring-tone, at least one, or a blend, of (a) licensable, digital rights-holder media, (b) digital non-rights-holder media, and (c) digital control-signal data, said method comprising
selectively placing digital (a) rights-holder media, (b) non-rights-holder media, and/or (c) control-signal data, as ring-tone snippet content in an electronic ring-tone snippet depot,
enabling controlled and sanctioned network-user access to that depot for the purpose of permitting selective user-extraction of at least one snippet derived from such depot-held snippet content, and
further enabling user-employment of such extracted content as at least a part of (a) a user-specific identifier, and/or (b) an ultimate, user-identifying action-stimulator, in relation to a user-to-user network communication.

3. The method of claim 2, wherein the user is a communication-initiating user.

4. A network inter-user ring-tone communication method employing, as a ring-tone, licensable rights-holder media, said method comprising
placing at least digital rights-holder media as ring-tone media snippet content in an electronic ring-tone snippet depot,
enabling controlled and sanctioned network-user access to that depot for the purpose of permitting selective user extraction of a snippet derived from such depot-held media snippet content,
further enabling user-employment of such extracted content as at least a part of (a) a user-specific identifier, and/or (b) an ultimate, user-identifying action-stimulator, in relation to a user-to-user network communication, and
in relation to said placing and enabling steps, effectively generating, and supplying to at least rights-holders who are contributors to the depot, a revenue stream which is based upon such contributions.

5. The method of claim 4, wherein the user is a communication-initiating user.

6. The method of claim 4, wherein media contributed to the depot includes at least one of (a) audio content, (b) imaging content (motion or still), (c) combined audio and imaging content, (d) text content and (e) text content combined with any one of (a), (b) and (c).

7. The method of claim 4, wherein enabled user-employment includes at least one of (a) direct use of an extracted and unmodified depot-contained rights-holder snippet, (b) modified, direct, rights-holder snippet use which includes user-selectable mixing of plural extracted depot-contained rights-holder snippets, and (c) modified, direct rights-holder snippet use which includes user-choosable mixing/blending of at least one extracted rights-holder snippet with depot-contained user-originated ring-tone snippet content.

8. The method of claim 4, wherein an ultimate action-stimulator may invoke at least one of (a) a recipient response to the related, extracted-snippet communication, and (b) the triggering of an automatic computer-based, or other machine-based, performance of a sender-selected or a recipient-selected action.

9. A digital network, inter-user, ring-tone communication system employing, as a ring-tone, at least digital rights-holder media comprising
an electronic ring-tone depot containing at least rights-holder digital media as ring-tone media snippet content,
network-user access structure operatively associated with, and selectively connectable to, said depot, enabling controlled and sanctioned network-user extraction of at least one media snippet derived from depot-contained media snippet content, and
use-enabling structure operatively associated with said access structure, operable to enable user-employment of such extracted content as at least a part of (a) a user-specific identifier, and/or (b) a communicable, user-identifying digital action-stimulator, in relation to a user-to-user digital network communication.

10. The method of claim 9, wherein the user is a communication-initiating user.
